(19) United States
(12) Patent Application Publication
(10) Pub. No.: US 2008/0315070 A1
(43) Pub. Date: Dec. 25, 2008

(54) Display apparatus and brightness adjustment method thereof

(75) Inventor: Pei-Chang Lee, Taoyuan (TW)

Correspondence Address: BACON & THOMAS, PLLC, 625 SLATERS LANE, FOURTH FLOOR, ALEXANDRIA, VA, 22314-1176, US

(73) Assignee: Qisda Corporation, Taoyuan (TW)

(21) Appl. No.: 12/213,408

(22) Filed: Jun. 19, 2008

(30) Foreign Application Priority Data
Jun. 23, 2007 (TW) 96122815

(51) Int. Cl. G01J 1/32

(52) U.S. Cl. 250/205

(57) ABSTRACT

A brightness adjustment method is applied to a display apparatus comprising a light source and a light sensor and includes the following steps. First, a target brightness value L1 is provided. Then, a detected value S2 of the light sensor is obtained by using the light sensor to detect brightness of the light source. Next, a detected brightness value L2 of the light source is obtained as the light sensor performs the detection. At last, the brightness of the light source is adjusted according to L1, L2 and S2.

This application claims the benefit of Taiwan application Serial No. 96122815, filed Jun. 23, 2007, the subject matter of which is incorporated herein by reference.

### BACKGROUND OF THE INVENTION

1. Field of the Invention

The invention relates in general to a display apparatus and a brightness adjustment method thereof, and more particularly to a display apparatus capable of correcting a light sensor and a brightness adjustment method thereof.

2. Description of the Related Art

In general, the Cold Cathode Fluorescent Lamp (CCFL) or Light Emitting Diodes (LED) is used as a light source in a flat panel display. However, the light-emitting efficiency of the light source decreases as the light source naturally ages, and therefore the consumers find the brightness of the monitor is darker than before. U.S. Pat. No. 6,448,550 and Taiwan Patent Publication No. 1263754 disclose a built-in sensing unit in a display device to feed back and control the brightness of the light source, so as to compensate the brightness of the monitor automatically and increase the product competitiveness.

In other words, the related processing unit in the display device can obtain the current brightness of the light source to compare with a predefined stored value, such as a default brightness value, and process the compensation, such as adjusting the driving electric current outputted to light tubes. Consequently, the sensing unit for setting the default brightness value must be sold with the display device to apply an identical standard to the correction for compensating the brightness. Otherwise, if the sensing unit 2 which is used as the display device is sold is not the original sensing unit 1 for detecting the default brightness value, the two sensing units may obtain different detected values due to the manufacturing or the fabricating inaccuracy even if the two sensing units are exactly the same.

For example, the detected value of the current brightness of the light source obtained by the sensing unit 2 is larger than that obtained by the sensing unit 1; meanwhile, the processing unit compares the detected value of the sensing unit 2 with the predefined stored value (obtained by the sensing unit 1) and thus the aging degree of the brightness is underestimated. Thus, the compensated brightness of the light source in the following adjusting steps is insufficient and the adjusting accuracy is influenced. In addition, if the sensing unit has to be changed due to damage or other situation, the above-mentioned problem is not avoidable even if the sensing unit is sold with the display device. That is, once the sensing unit is different, the display device will not be accurately adjusted because the display device can only be adjusted to an adjusted brightness of a corresponding sensing unit.

### SUMMARY OF THE INVENTION

The invention is directed to providing a display apparatus and a brightness adjustment method thereof. The display apparatus can automatically correct a light sensor being used therein, so that the display apparatus can be adjusted to a required constant brightness without any influence of using a different kind of light sensor. Thus, the light sensor needs not be sold with the display apparatus, and the manufacturing and the maintaining are more flexible.

According to a first aspect of the present invention, a brightness adjustment method applied to a display apparatus is provided. The display apparatus comprises a light source and a light sensor. The method comprises the steps stated below. (a) First, a target brightness value L1 is provided. (b) Then, a detected value S2 of the light sensor is obtained by using the light sensor to detect brightness of the light source. (c) Next, a detected brightness value L2 of the light source is obtained as the light sensor performs the detection. (d) At last, the brightness of the light source is adjusted according to the target brightness value L1, the detected brightness value L2 and the detected value S2.

According to a preferred embodiment of the method in the first aspect of the invention, the above-mentioned step (c) comprises: (c1) a look-up table is provided; (c2) an accumulated driving time T2 of the light source is obtained as the light sensor performs the detection; and (c3) the detected brightness value L2 is obtained from the look-up table according to the accumulated driving time T2.

According to the preferred embodiment of the method in the first aspect of the invention, the detected brightness value L2 of the above-mentioned light source and the above-mentioned accumulated driving time T2 of the light source have an inverse correlation under a driving setting, and the look-up table comprises data corresponding to the inverse correlation.

According to the preferred embodiment of the method in the first aspect of the invention, in the above-mentioned step (b), the light source is under the above-mentioned driving setting.

According to the preferred embodiment of the method in the first aspect of the invention, in the above-mentioned step (d), the brightness of the light source is adjusted so that the detected value S2 of the light sensor is positively correlated with (L1/L2)×S2 as the light sensor detects the adjusted brightness of the light source.

According to the preferred embodiment of the method in the first aspect of the invention, the detected value S2 of the above-mentioned light sensor and the detected brightness value L2 substantially have a linear relationship.

According to the preferred embodiment of the method in the first aspect of the invention, the detected value S2 of the above-mentioned light sensor is a voltage value or a frequency value.

According to a second aspect of the present invention, a display apparatus is provided. The display apparatus comprises a light source, a light sensor and a control module. The light sensor is used for detecting brightness of the light source. The control module, coupled to the light source and the light sensor, is used for driving the light source. The control module stores a target brightness value L1 and a look-up table. When the display apparatus is in an adjustment mode, the light sensor detects the brightness of the light source to obtain a detected value S2 for being outputted to the control module. The control module obtains a detected brightness value L2 of the light source as the light sensor performs the detection by the use of the look-up table so as to adjust the brightness of the light source according to L1, L2 and S2.

According to a preferred embodiment of the apparatus in the second aspect of the invention, when the display apparatus is in the above-mentioned adjustment mode, the control module obtains the detected brightness value L2 from the look-up table according to an accumulated driving time T2 of the light source.

According to the preferred embodiment of the apparatus in the second aspect of the invention, the detected brightness value L2 of the above-mentioned light source and the accumulated driving time T2 of the above-mentioned light source show an inverse correlation under a driving setting, and the look-up table comprises data corresponding to the inverse correlation.

According to the preferred embodiment of the apparatus in the second aspect of the invention, when the above-mentioned display apparatus is in the adjustment mode, the light source is under the above-mentioned driving setting.

According to the preferred embodiment of the apparatus in the second aspect of the invention, the above-mentioned control module adjusts the brightness of the light source so that the detected value S2 of the light sensor is positively correlated with (L1/L2)×S2 as the light sensor detects the adjusted brightness of the light source.

According to the preferred embodiment of the apparatus in the second aspect of the invention, the detected value S2 of the above-mentioned light sensor and the detected brightness value L2 substantially have a linear relationship.

According to the preferred embodiment of the apparatus in the second aspect of the invention, the detected value S2 of the above-mentioned light sensor is a voltage value or a frequency value.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic view of a display apparatus according to a preferred embodiment of the invention.

FIG. 2 is a relation graph of the detected brightness value L2 of the light source and the accumulated driving time T2.

FIG. 3 is a flowchart of a brightness adjustment method of the display apparatus according to the preferred embodiment of the invention.

### DETAILED DESCRIPTION OF THE INVENTION

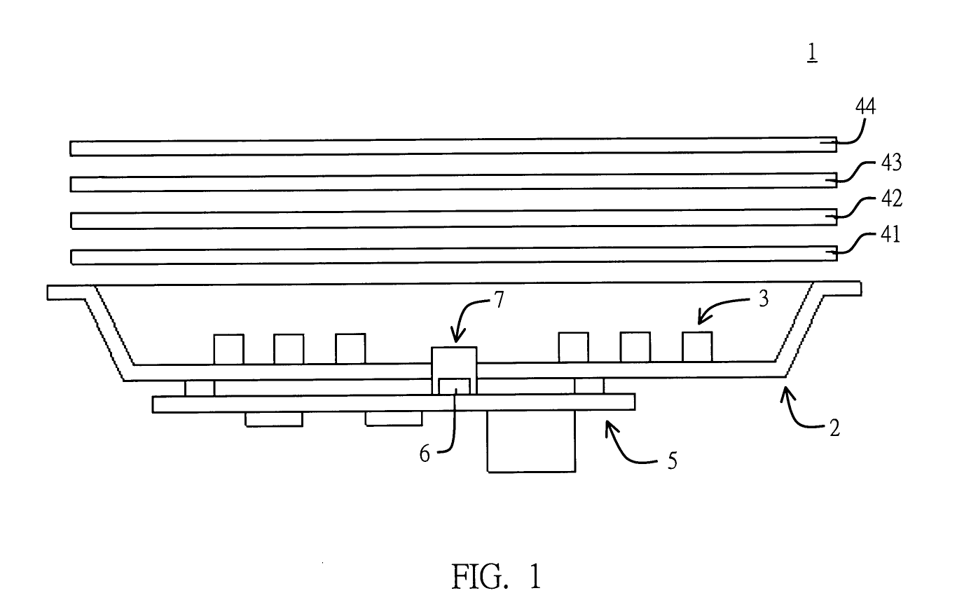

Referring to FIG. 1, a schematic view of a display apparatus according to a preferred embodiment of the invention is shown. The display apparatus 1, such as a Liquid Crystal Device (LCD), comprises a back frame 2, a light source 3, several optical sheets 41-44, a control module 5, a light sensor 6 and a light guide tube 7. The light source 3, such as several light tubes or Light Emitting Diodes (LED), is disposed at the bottom surface of the back frame 2 and driven to radiate by the control module 5. The light sensor 6 detects brightness of the light source 3 by light guiding of the light guide tube 7. The light generated by the light source 3 radiated to a liquid crystal panel (not shown) of the display apparatus 1 after being processed by the optical sheets 41-44. A driving circuit of the control module 5 for driving the light source 3 is capable of recording the radiation time of the light source 3 according to the oscillation time of an inner oscillator. Besides, the control module 5 stores a look-up table.

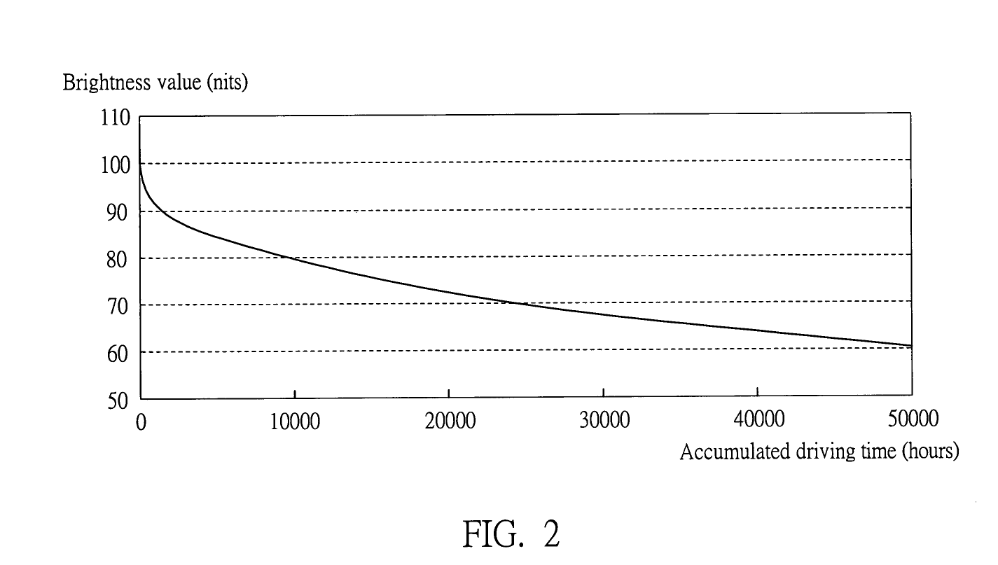

Referring to FIG. 2, a relation graph of the detected brightness value of the light source and the accumulated driving time is shown. In general, light is tested on its lifetime and aging efficiency. When testing, the light radiates continuously under a driving setting (such as fixed driving electric current, environmental temperature and other related parameters), and the variation of the detected brightness value L2 changed along with the time passing is recorded by the related examining apparatus, as shown in FIG. 2. Once the testing result reaches a required standard, the display apparatus will be manufactured and fabricated greatly so as to ensure the product quality and consumers' rights.

Therefore, the detected brightness value L2 substantially reveals the variation shown in FIG. 2 if the light source 3 radiates under the same driving setting. In the present embodiment of the invention, the look-up table stored in the control module 5 is the test data as shown in FIG. 2. That is, the input value of the look-up table is the accumulated driving time (the horizontal axis of FIG. 2) and the corresponding output value is the detected brightness value L2 (the longitudinal axis of FIG. 2). Thus, the control module 5 sets the corresponding output value of the look-up table as the current brightness value of the light source 3 according to the accumulated driving time of the light source 3, so that the light sensor 6 performs a brightness adjustment (specified below) on the light source 3 based on an adjustment basis.

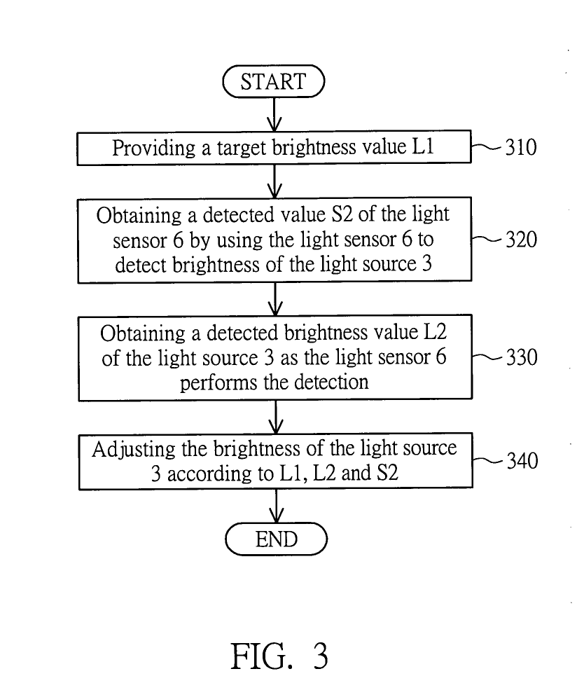

Referring to FIG. 3, a flowchart of a brightness adjustment method of the display apparatus 1 according to the preferred embodiment of the invention is shown. First, as shown in step 310, a target brightness value L1 is provided. The target brightness value L1 could be set by users via an input device of a computer, or could be a predefined target brightness value L1, such as a default brightness value, stored in a processing unit of the control module 5. In FIG. 2, as the 0 hour is the default time, L1 is the brightness value 100 (nits) corresponding to the 0 hour.

Then, as shown in step 320, a detected value S2 of a light sensor 6 is obtained by using the light sensor 6 to detect brightness of the light source 3. The display apparatus 1 could be switched to an adjustment mode by users via a button of the display apparatus 1, and the display apparatus 1 could also be switched to the adjustment mode with a software controlled by users through an output device. In the present embodiment of the invention, when the display apparatus 1 is in the adjustment mode, the control module 5 drives the light source 3 according to the above-mentioned driving setting, and the detected value S2 (such as a voltage value or a frequency value of an electronic signal) of the light sensor 6 is outputted to the control module 5 to be processed.

Next, as shown in step 330, a detected brightness value L2 of the light source 3 is obtained as the light sensor 6 performs the detection. As mentioned above, the control module 5 sets the corresponding output value of the look-up table as the current brightness value L2 of the light source 3 according to the accumulated driving time of the light source 3 as the light sensor 6 performs the detection. The actual brightness value of the light source 3 is substantially the same with the corresponding output value of the look-up table because the light source 3 is driven according to the driving setting identical to the test data in FIG. 2 in the adjustment mode. Taking an example of the accumulated driving time of the light source 3 being 10000 hours as the light sensor 6 performs the detection, L2 could be set as 80.

At last, as shown in step 340, the brightness of the light source 3 is adjusted according to L1, L2 and S2. In the above-mentioned steps, it is known that L=100 and L2=80, i.e. the current brightness value of the light source 3 decreases about ⅕ than the detected brightness value of the light source 3 when the display apparatus 1 was manufactured. In addition, the detected value S2 of the light sensor 6 and the detected brightness value substantially have a linear relationship. Therefore, the control module 5 enhances the detected brightness value of the light source 3 until the detected value S2 of the light sensor 6 raises 1.25 time (1.25×S2) when the light sensor 6 detects the adjusted brightness value of the light source 3. At this time, the detected brightness value of the light source 3 substantially raises 1.25 times, i.e. L1/L2, enhancing from L2 to the target brightness value L1.

Accordingly, the detected brightness value of the light source 3 could be adjusted to the target brightness value L1 no matter what the detected value S2 of the light sensor 6 is. That is, an identical adjusting basis could be obtained in the step 330 even though a different light sensor is used. Besides, using a different light sensor makes no difference to the adjusted brightness obtained in the step 340. Therefore, the display apparatus 1 has no restriction on using the specific light sensor 6 and can be used with other light sensors afterward. Also, the light sensor is not restricted to be disposed at the same position so as to increase the manufacturing and fabricating flexibility. In the other embodiments, the display apparatus could certainly be an Organic Light Emitting Diodes (OLED) device and the light source comprises an emissive display panel composed by several OLEDs arranged in a matrix.

The display apparatus and the brightness adjustment method thereof according to the preferred embodiments of the invention are capable of automatically correcting the light sensor being used, so as to obtain the required constant brightness without any influence of using a different kind of light sensor. Therefore, the light sensor is not bound to be sold with the display apparatus, and the manufacturing and the maintaining are more flexible.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A brightness adjustment method applied to a display apparatus, wherein the display apparatus comprises a light source and a light sensor, the brightness adjustment method comprising the steps of:
(a) providing a target brightness value L1;
(b) obtaining a detected value S2 of the light sensor by using the light sensor to detect brightness of the light source;
(c) obtaining a detected brightness value L2 of the light source as the light sensor performs the detection; and
(d) adjusting the brightness of the light source according to the target brightness value L1, the detected brightness value L2 and the detected value S2.

2. The method according to claim 1, wherein the step (c) comprises:
(c1) providing a look-up table;
(c2) obtaining an accumulated driving time T2 of the light source as the light sensor performs the detection; and
(c3) obtaining the detected brightness value L2 from the look up table according to the accumulated driving time T2.

3. The method according to claim 2, wherein the detected brightness value L2 of the light source and the accumulated driving time T2 of the light source have an inverse correlation under a driving setting, and the look-up table comprises data corresponding to the inverse correlation.

4. The method according to claim 3, wherein, in the step (b), the light source is under the driving setting.

5. The method according to claim 1, wherein, in the step (d), the brightness of the light source is adjusted so that the detected value S2 of the light sensor is positively correlated with (L1/L2)×S2 as the light sensor detects the adjusted brightness of the light source.

6. The method according to claim 1, wherein the detected value S2 of the light sensor and the detected brightness value L2 substantially have a linear relationship.

7. The method according to claim 1, wherein the detected value S2 of the light sensor is a voltage value or a frequency value.

8. A display apparatus, comprising:
a light source;
a light sensor for detecting brightness of the light source; and
a control module, coupled to the light source and the light sensor, for driving the light source and storing a look-up table;
wherein when the display apparatus is in an adjustment mode, the light sensor detects the brightness of the light source to obtain a detected value S2 for being outputted to the control module, the control module obtains a detected brightness value L2 of the light source as the light sensor performs the detection by the use of the look-up table so as to adjust the brightness of the light source according to a target brightness value L1, a detected brightness value L2 and a detected value S2.

9. The display apparatus according to claim 8, wherein when the display apparatus is in the adjustment mode, the control module obtains the detected brightness value L2 from the look-up table according to an accumulated driving time T2 of the light source.

10. The display apparatus according to claim 9, wherein the detected brightness value L2 of the light source and the accumulated driving time T2 of the light source have an inverse correlation under a driving setting, and the look-up table comprises data corresponding to the inverse correlation.

11. The display apparatus according to claim 10, wherein when the display apparatus is in the adjustment mode, the light source is under the driving setting.

12. The display apparatus according to claim 8, wherein the control module adjusts the brightness of the light source so that the detected value S2 of the light sensor is positively correlated with (L1/L2)×S2 as the light sensor detects the adjusted brightness of the light source.

13. The display apparatus according to claim 8, wherein the detected value S2 of the light sensor and the detected brightness value L2 substantially have a linear relationship.

14. The display apparatus according to claim 8, wherein the detected value S2 of the light sensor is a voltage value or a frequency value.
